(19) United States
(12) Patent Application Publication
(10) Pub. No.: US 2026/0175515 A1
(43) Pub. Date: Jun. 25, 2026

(54) Apparatus And Method For 3D Printing With Material Including Solid Particles

(71) Applicant: Massivit 3D Printing Technologies Ltd., Lod (IL)

(72) Inventors: Gershon Miller, Rehovot (IL); Igor Yakubov, Herzelia (IL)

(21) Appl. No.: 19/426,223

(22) Filed: Dec. 19, 2025

(30) Foreign Application Priority Data
Dec. 23, 2024 (IL) 317963

(51) Int. Cl. B29C 64/165; B22F 12/53; B22F 12/55; B22F 12/58; B28B 1/00; B29C 64/188; B29C 64/209; B29C 64/336; B33Y 10/00; B33Y 40/00; B33Y 70/10

(52) U.S. Cl. CPC B29C 64/165; B22F 12/53; B22F 12/55; B22F 12/58; B28B 1/001; B29C 64/188; B29C 64/209; B29C 64/336; B33Y 10/00; B33Y 40/00; B33Y 70/10

(57) ABSTRACT

A system for manufacturing 3D objects, including at least one nozzle, configured to deliver at least one fluid component into a material receiving volume. The system further comprises a mechanism configured to deliver solid or high-viscosity fluid particles into the material receiving volume and a mechanism configured to reposition and shake the material receiving volume to remove gas inclusions trapped between the solid particles and fluid material components and to achieve a homogeneous distribution of particles within a polymer matrix.

### TECHNOLOGY FIELD

The apparatus and method relate to composite material manufacturing, particularly with materials including fluids, pastes, and solids.

### BACKGROUND

A composite material is a material that is produced from two or more materials joined together. The materials could have dissimilar chemical or physical properties. The resulting composite material possesses properties different from those of the joined materials.

Composite materials are widely used in industry and science. The materials possess unique properties and can withstand simultaneous high-intensity mechanical, physical, and thermal loads. The materials have smaller specific weights than metals or stones. Some of the composite materials, for example, carbon-ceramic composites, are stronger than metals.

Composite materials with inclusions of solid materials allow the combination of different components to achieve specific mechanical, thermal, or electrical properties. These composites are a matrix material with reinforcing inclusions or particles (such as stones, metal, or other solid particles) embedded within one or more material layers. The material and shape of the inclusions could be considered, and they could assist in the manufacture of composites with different properties.

In some cases, the reinforcing particles may provide for increased friction, high resistance to abrasion, enhanced strength, and additional material properties. The reinforcing particles or inclusions may be of the same material and shape. Depending on the desired properties, they may be of different materials, shapes, and sizes. The role of reinforcement is to provide strength and stiffness to the material. The matrix protects the reinforcing material from adverse environmental effects.

United States Patent application publication 2019/0039309 to Busbee et al. describes a method of printing a footwear 3D article where at least one of the two or more input materials comprising particles (e.g., reinforcing particles). The same nozzle extrudes the mix of fluids and particles towards the printing substrate.

U.S. Pat. No. 10,464,031 to Lewis describes a method of printing a 3D article using an active fluid mixing nozzle, where an impeller mixes at least two fluids into one fluid being ejected from the same nozzle.

### DEFINITIONS

In the context of the present disclosure, particulate material means small high-viscosity fluid or solid particles present in the material. The size of the particles could be 0.2 to 5 mm. The particles are suspended in a lower viscosity fluid. The particles could be organic and inorganic particles.

### SUMMARY

The present disclosure is directed to a system and method for manufacturing three-dimensional objects. The system includes at least one nozzle configured to deliver into a material receiving volume at least one fluid component; at least one mechanism configured to provide solid or high viscosity fluid particles into the material receiving volume; and a mechanism configured to reposition and shake the material receiving volume to remove gas inclusions trapped between the solid particles and fluid material components and to achieve a homogeneous distribution of particles within a polymer matrix.

The material receiving volume is a repositionable material receiving volume and could be mounted on a system chassis or on a separate support. The shape of the material receiving volume is one of a group of rectangular, triangular, round, elliptical, or an arbitrary shape.

The material receiving volume receives both solid and fluid components of the material. Shaking the material receiving volume by application of mechanical vibrations, variable magnetic field, and thermal field, sets the relation and physical location between the solid particles and the material fluid component.

The variable magnetic field organizes a concentration of solid magnetic particles in a desired order and location within the material receiving volume. The material receiving volume fluid content is hardened by heat or actinic radiation. The fluid component of the material could include epoxy, polyurethane, polyester, and concrete components.

The solid particles include stones, silica, gravel, chopped fiber, high-viscosity fluid particles, and magnetic metal particles.

The generated in the material receiving volume material could be used in a method of manufacture of 3D objects. The method includes: providing a material receiving volume accepting both fluid and solid material components and at least one nozzle configured to deliver into the material receiving volume at least one fluid component and a mechanism configured to deliver into the material receiving volume solid particles, Shaking the material receiving volume to remove gas inclusions trapped between the solid and fluid material components and provide a homogenous distribution of solid particles. Alternatively, the solid particles could be organized in a desired location within the material receiving volume. Heat or actinic radiation is used to harden the material receiving volume content.

### BRIEF DESCRIPTION OF THE DRAWINGS

Examples of some system implementations will now be described concerning the accompanying schematic drawings in which corresponding reference symbols indicate corresponding parts.

FIG. 1 schematically depicts a typical print head with multiple fluid and particulate material inlets;

FIG. 2 is a schematic illustration of the present system for 3D printing with fluid and particulate material components;

FIG. 3A is a schematic illustration of the process of mixing the fluid and solid components of the material;

FIG. 3B is a schematic illustration of a step in the process of mixing the fluid and solid components of the material;

FIG. 3C is a schematic illustration of a further step in the process of mixing the fluid and solid components of the material;

FIG. 3D is a schematic illustration of the process of mixing the fluid and solid magnetic particles;

FIG. 3E is another schematic illustration of the process of mixing the fluid and solid magnetic particles;

FIG. 4A is a schematic illustration of the process of mixing the low-viscosity fluid and high-viscosity fluid components of the material;

FIG. 4B is a schematic illustration of a further step in the process of mixing the low-viscosity fluid and high-viscosity fluid components of the material; and

FIG. 5 is a flowchart of the method of composite article preparation according to the present method.

### DETAILED DESCRIPTION OF EMBODIMENTS

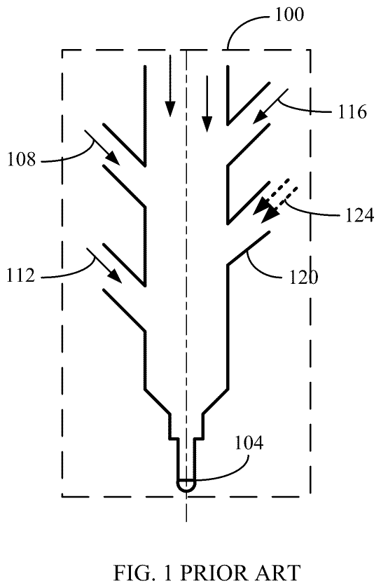

The conventional preparation of the printing material requires mixing several components that form the material. Typically, as illustrated in FIG. 1, the print head 100 may have a printing nozzle 104 and two or more fluid material inlets 108-116 in fluid communication with the printing nozzle 104. One of the material inlets, e.g., 120, could be configured to deliver particulate or solid material 124, which could be stone, metal, paste, gel, or plastic particles. The nozzle 104 combines or mixes the fluid and particulate material and ejects the mix. The mixing of the printing material components could be a mechanical mix, although some chemical reactions or processes between the printing material components could take place. The nozzle opening diameter or size limits the size of the particulate material particles that could be ejected.

All known to the inventor's patents or applications use a mix of fluid and “solid” materials. The mixture of materials occurs in the nozzle or close to the nozzle (including the mixture of cementitious materials). None of the patents or applications mix the materials in a place different from the nozzle that the current disclosure suggests.

Accordingly, this disclosure aims to provide an improved apparatus for continuously mixing and casting viscous fluids, such as polymers, with particulate solids or high-viscosity fluid particles without limiting the dimensions of the solid particles or inclusions.

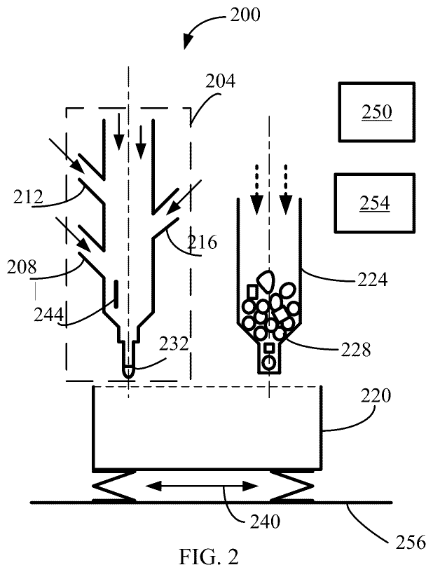

FIG. 2 is a schematic illustration of the present system for 3D printing or casting with fluid components and particulate material. System 200 includes fluid delivery subsystem 204 with one or more fluid inlets 208-216, a material receiving volume 220, and a mechanism 224 configured to deliver solid particles 228 into the material receiving volume 220. Although three fluid inlets are illustrated in FIG. 2, a more significant or smaller amount of fluid inlets is also possible.

Computer 250 controls the operation of system 200, particularly the operation of nozzle 232, including the deposition and amount of the mixture of fluids 208-216 material into the material receiving volume 220. Similarly, computer 250 controls the operation of mechanism 224, configured to deliver solid particles 228 into the material receiving volume 220.

System 200 could also include a source of fluid hardening or actinic radiation 254. The hardening radiation operates to harden the fluid components of the material receiving volume 220. The source of fluid hardening radiation could be one of a group of sources such as UV radiation, IR radiation, heat or other types of radiation capable of hardening or curing the fluid components.

The application of heat could accelerate the fluid components' hardening process. The heat could be applied, for example, by heating the material receiving volume 220.

In some examples, the shape of the material receiving volume could be rectangular, triangular, round, elliptical, or arbitrary. The receiving volume could have a base of 300 mm by 500 mm, 200 mm by 700 mm, or any other size. The 3D object to be printed defines the size of the material receiving volume and the depth of the material receiving volume. The material receiving volume 220 movement, indicated by arrow 240, also supports the formation of a homogenous layer of the particulate material.

An ejection nozzle 232 terminates fluid delivery subsystem 204. Fluid delivery subsystem 204 is configured to deliver into the material receiving volume 220 at least one fluid component or a mixture of several fluid components. Typically, the mixture of the fluid components takes place in the nozzle. For example, one or more fluid inlets 208-216 could receive a mixture of the fluids.

The fluid components could be epoxy, polyurethan, polyester, and concrete.

Typically, but not necessarily, the nozzle 232 opening is round. If necessary or desired, the nozzle can be exchanged. The size of the printer nozzle and the printer nozzle opening shape could be different. Depending on the 3D object printing requirements, the printer nozzle can have a hexagonal opening, a triangular or rectangular, star type, and other cross-section openings.

In some examples, the nozzle may include one or more sensors 244 to measure the temperature of fluids mixing, control the fluids flow, and, e.g., the speed of the fluids at the inputs to the nozzle and the mixture of fluids output speed. Computer 250 also collects and processes the signals provided by one or more sensors 244.

Computer 250 controls the nozzle operation, including the material's deposition and amount into the material receiving volume 220. Computer 250 also controls the temperature of the material receiving volume 220. Computer 250 may govern and control the operation of system 200. The control may include the dosing of fluid materials and particulate material, the shaking process frequency, the viscosity of the fluid, and the fluid's vibration amplitude. In some examples sonic or ultrasonic frequencies application could be used for shaking the material receiving volume 220. Shaking the material receiving volume 220 sets a relation and physical location between the solid material particles 228 and fluid components. Alternatively, one or more controllers could govern and control the operation of system 200.

Computer 250 also receives the printed 3D object information. The 3D object information could include the shape of the 3D object and the thickness of the 3D object to be produced. The thickness of the 3D object defines the number of composite material layers to be printed. The composite material layers could be of identical thickness or of different thickness. The size of the solid particles defines the thickness of the composite material layer.

The fluids could include one or more curing agents configured to be activated by light and/or heat exposure. The fluids could be high-viscosity fluids/pastes/gels with a viscosity of up to 2.000.000 cP.

In some examples, at least one of the fluids comprises a polymer resin and at least one of the fluids comprises a harder fluid, for example, Sika Biresin® G48 with G55 hardener material and TE filler (Aluminium powder) commercially available from SIKA Corporation, 201 Polito Avenue, Lyndhurst, New Jersey 07071 U.S.A.

The material receiving volume 220 could be mounted on a common with other systems units, basis or chassis 256. In some examples, the material receiving volume 220 could be mounted on a separate support. The material receiving volume 220 could have one of a group of shapes such as rectangular, triangular, round, elliptical, or an arbitrary or free shape. The material receiving volume 220 shape could be selected to match the shape of the 3D object to be produced. The material receiving volume 220 mounting includes a mechanism marked by arrow 240, configured to reposition and shake the material receiving volume 220. The shaking or vibration of material receiving volume 220 removes gas inclusions that could be trapped between the solid particles and fluid material components and achieves a homogeneous distribution of solid particles within the polymer matrix.

Mechanism 224 is configured to deliver solid particles that could be fillers 228 into the material receiving volume 220. The solid particles are a group of particles that include stones, silica, gravel, chopped fiber, and metal.

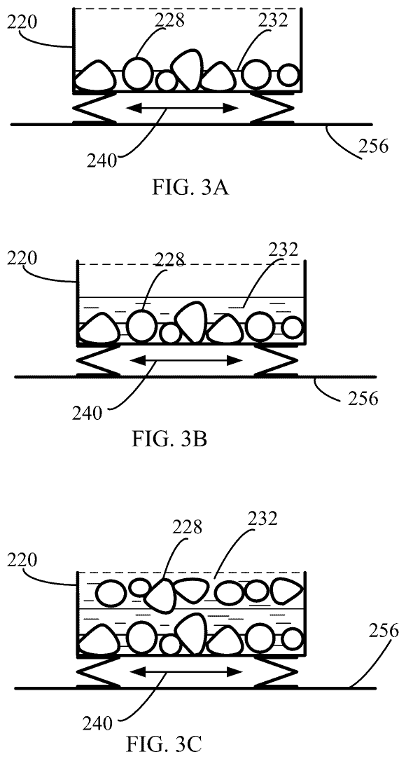

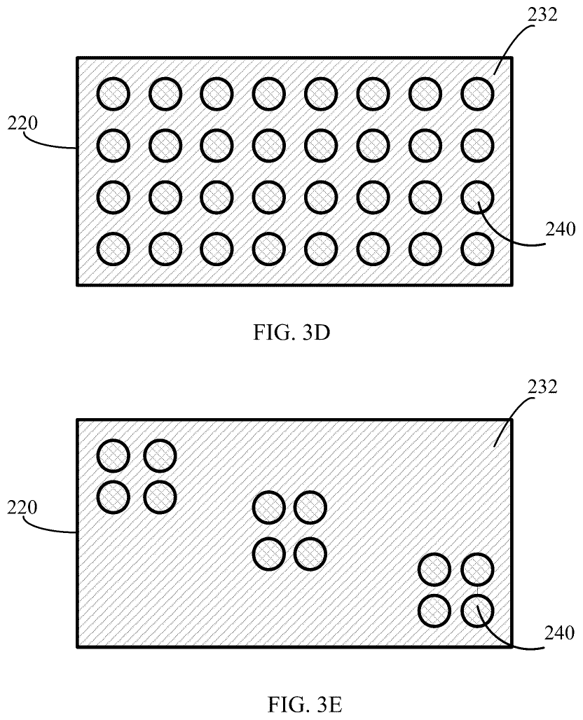

FIG. 3 is a schematic illustration of the process of mixing the fluid and solid components of the material. Numeral 228 marks the solid components or inclusions into the material of a 3D object to be produced. FIG. 3A is a schematic illustration of the process of mixing the fluid and solid components of the material. The 3D object may be formed from various fluids and solid particles. The fluid 232 is deposited first into the material receiving volume 220. The solid particles 228 are introduced into the material receiving volume 220 when the height or depth of the fluid 232 material is at least 0.5 mm. The particulate material, solid particles 228 is deposited at that fluid level. In some examples, the particulate material is deposited first into the material receiving volume 220.

FIG. 3B is a schematic illustration of a next step in the process of mixing the fluid and solid components of the 3D object material. Computer 250 continues the fluid supply until the fluid 232 material completely covers the particulate material 228 in the material receiving volume 220. A source 252 of 3D material hardening radiation becomes operative and hardens fluid 232.

FIG. 3C is a schematic illustration of a further step in the process of mixing the fluid 232 and solid components 228 of the material. Upon completion of the hardening of the earlier deposited fluid layers, system 200 deposits the next layer of fluid 232 material and solid particulate material 228.

FIG. 3D is a schematic illustration of the process of mixing the fluid and solid magnetic particles. FIG. 3D illustrates application of a magnetic field to form a uniform distribution of the solid magnetic particles within the material. Numeral 240 marks the magnetic particles.

FIG. 3E is another schematic illustration of the process of mixing the fluid and solid magnetic particles. The magnetic field is organized and applied to generate a concentration of solid magnetic particles 240 in a desired region of the fluid 232.

System 200 continues the process of the deposition of the fluid with solid particles, until the desired thickness of the 3D object is reached.

In some examples, the solid particles are droplets of high-viscosity fluids. The high-viscosity fluid could have a viscosity of about 2.000.000 cP or more. Such high-viscosity fluid could be any of the high temperature epoxy tooling systems commercially available from SIKA Corporation, 201 Polito Avenue, Lyndhurst, New Jersey 07071 U.S.A.

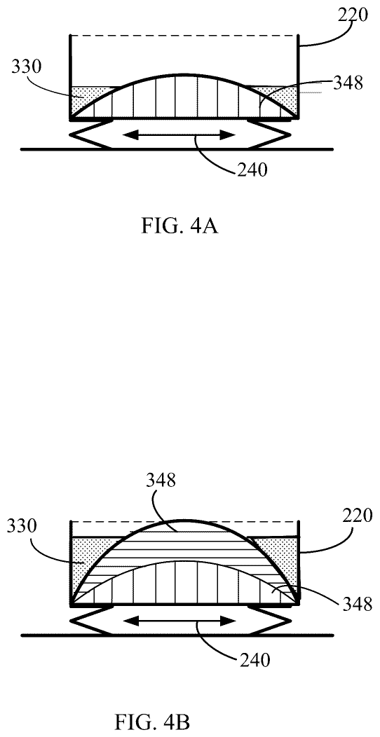

FIG. 4A is a schematic illustration of a mixture of high-viscosity fluid particles in a low-viscosity fluid. In some examples, the low-viscosity fluid 330 filling the material receiving volume 220 could be such as one of the Sikadur family fluids commercially available from SIKA Corporation. The low-viscosity fluid 330 could have a similar chemical composition as the high-viscosity fluid 348 particles have. The low-viscosity fluid 330 will dissolve certain volumes of the high-viscosity fluid (FIG. 3D) and form a homogenous mass of material spreading in the material receiving volume 220. Low viscosity fluid provides details of the 3D object printed. The high viscosity particles stabilize their location and the material properties.

FIG. 4A schematically illustrates the beginning of the process. Initially, a low-viscosity fluid of 330 is delivered into the material receiving volume 220. Immediately after that or even simultaneously with the delivery of a low viscosity fluid 330 particles or even layers of the high-viscosity fluid 348 are delivered into material receiving volume 220. The low viscosity fluid 330 at least partially dissolves particles or even layers of the high-viscosity fluid 348 delivered into material receiving volume 220.

FIG. 4B schematically illustrates the next step in the process of mixing low-viscosity fluid 330 with a high-viscosity fluid 348. Proper mixing of the high and low viscosity fluids forms a homogenous mass of material spreading in the material receiving volume 220.

The shaking of the material receiving volume 220 could be by applying mechanical vibrations, by a variable magnetic field that would steer the magnetic metal particles within the fluid in the material receiving volume 200, sonic and ultrasonic waves, and thermal field. The application of a magnetic field could have some advantages. The magnetic field could organize the magnetic metal particles in a desired pattern, as illustrated in FIGS. 3D-3E.

Although the printed 3D object is shown as a planar object, in some examples, nonplanar 3D objects could be printed.

In some examples, the printed 3D object could serve as a basis for additional segments of a complex article to be produced.

System 200 also includes a source of fluid hardening or actinic radiation 254. The hardening radiation operates to harden the fluid components of the material receiving volume 220. The source of fluid hardening radiation could be a group of sources such as UV radiation, IR radiation, heat or other types of radiation capable of hardening or curing the fluid components.

### Workflow Description

FIG. 3 is a schematic illustration of the process of mixing the fluid and solid components of the material. The 3D object may be formed from various fluids and solid particles. The fluid is deposited first into the material receiving volume 220. The solid particles 228 are introduced into the material receiving volume 220 when the height or depth of the fluid materials is at least 0.5 mm. FIG. 3A. Computer 250 continues the fluid supply until the fluid material completely covers the particulate material in the material receiving volume 220.

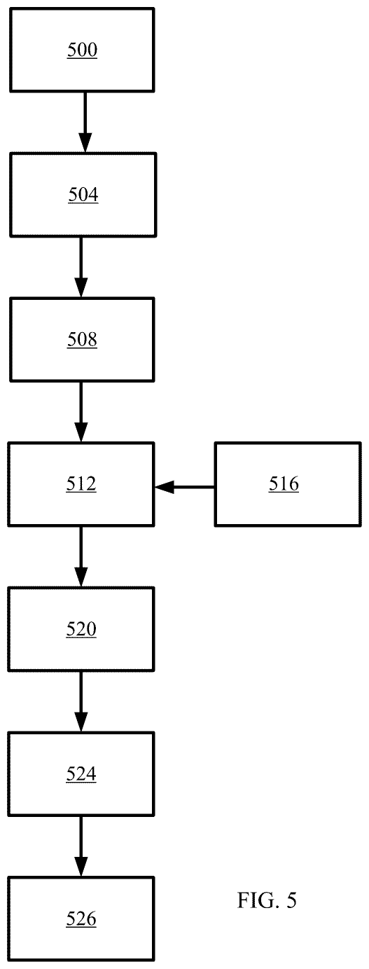

FIG. 5 is a flowchart of the method of composite article preparation according to the present process.

In step 500, computer 250 is employed to control the mixing of the fluids and prepare a mixture of fluids to account for the desired fluids mixing ratio.

In step 508, the system generates and maintains the optimal temperature for of preparing the mixture of fluids. Heating and cooling may, for example, be used to control mixing and consistency within the prepared material.

In step 512, the system delivers the required amount of the mixture of fluids into the material receiving volume. The amount of the mixture is sufficient to fill the material receiving volume to form a layer of at least 0.5 mm depth.

Concurrently or sequentially, in step 516, the system selects the proper size and shape of the particulate material and delivers the material into the material receiving volume.

In step 520, the system shakes the material receiving volume to get a homogenous distribution of the particulate material.

In step 524, the system continues to deliver the required amount of the mixture of fluids into the material receiving volume until the mix of fluids covers all particulate material by the material of at least 0.2 mm, exceeding the level of the particulate material.

In step 526, the system operates the hardening radiation sources to harden the fluid content of the material receiving volume

The method and apparatus have been described in detail. Concerning specific examples thereof, it will be apparent to one of ordinary skill in the art that various changes and modifications can be made to the method and apparatus without departing from the spirit and scope thereof.

We claim:

1. A system for the manufacture of 3D objects comprising:
at least one nozzle configured to deliver into a material receiving volume at least one fluid component;
at least one mechanism configured to provide solid or high viscosity fluid particles into the material receiving volume; and
a mechanism configured to reposition and shake the material receiving volume to remove gas inclusions trapped between the solid particles and fluid material components and to achieve a homogeneous distribution of particles within a polymer matrix.

2. The system of claim 1, wherein the material receiving volume is one of a group of material receiving volumes mounted on a system chassis or a separate support.

3. The system of claim 2, wherein the material receiving volume is a repositionable material receiving volume.

4. The system of claim 1, wherein shape of the material receiving volume is one of a group of rectangular, triangular, round, elliptical, or an arbitrary shape.

5. The system of claim 1, wherein shaking the material receiving volume sets a relation and physical location between solid material and fluid component.

6. The system of claim 1, wherein shaking the material receiving volume is by application of mechanical vibrations, variable magnetic field, and thermal field.

7. The system of claim 6, wherein the variable magnetic field organizes a concentration of solid magnetic particles in a desired order and location within the material receiving volume.

8. The system of claim 1, wherein the material receiving volume fluid content is hardened by heat or actinic radiation.

9. The system of claim 1, wherein the fluid component is one of a group of fluids including epoxy polyurethan, polyester, and concrete.

10. The system of claim 1, wherein the solid particles are one of a group of particles including stones, silica, gravel, chopped fiber, high-viscosity fluid particles, and metal.

11. The system of claim 1, wherein a shape of the material receiving volume is one of a group of rectangular, triangular, round, elliptical, or an arbitrary shape.

12. The system of claim 1, wherein shaking the material receiving volume sets a relation and physical location between solid material particles and fluid component.

13. The system of claim 1 wherein the solid particles include a high-viscosity fluid particles.

14. A method of manufacture of 3D objects comprising:
providing a material receiving volume accepting both fluid and solid material components;
providing at least one nozzle configured to deliver into the material receiving volume at least one fluid component;
providing at least one mechanism configured to deliver into the material receiving volume solid particles and
shaking the material receiving volume to remove gas inclusions trapped between the solid and fluid material components and provide a homogenous distribution of solid particles.

15. The method of claim 14, wherein the material receiving volume shape is one of a group of the shapes rectangular, triangular, round, elliptical, or an arbitrary shape.

16. The method of claim 14, wherein shaking the material receiving volume sets a relation and physical location between the solid material and fluid component.

17. The method of claim 14, wherein hardening the material receiving volume content by heat or actinic radiation.

18. The method of claim 14, wherein the fluid component is one of a group of fluids including epoxy, polyurethan, polyester, and concrete.

19. The method of claim 14, wherein the solid particles are one of a group of particles including stones, silica, gravel, chopped fiber, high viscosity fluid droplets, and metal magnetic particles.

20. The method of claim 14, wherein the material receiving volume is a repositionable material receiving volume.

21. The method of claim 14, wherein shaking the material receiving volume sets a relation and physical location between the solid material and fluid component.
